(19) United States
(12) Patent Application Publication
(10) Pub. No.: US 2024/0193687 A1
(43) Pub. Date: Jun. 13, 2024

(54) SYSTEMS AND METHODS FOR COMPUTER IMPLEMENTED TRADING CARD MARKETPLACE

(71) Applicant: William Matthew Eisler, Scarsdale, NY (US)

(72) Inventor: William Matthew Eisler, Scarsdale, NY (US)

(21) Appl. No.: 18/534,183

(22) Filed: Dec. 8, 2023

Related U.S. Application Data
(60) Provisional application No. 63/431,148, filed on Dec. 8, 2022.

(51) Int. Cl. G06Q 40/04

(52) U.S. Cl. CPC G06Q 40/04

(57) ABSTRACT

A computer implemented method in a data processing system that can include a processor and a memory that can include instructions, which can be executed by the processor that can cause the processor to implement the method of facilitating exchanges of trading cards between one or more users. The method can include receiving, from a first user a plurality of trading card records; generating, by the processor, a first trading card portfolio; assigning, by the processor, the first plurality of trading card records to the first trading card portfolio; executing, by the processor, a transaction; and updating, by the processor, based on the executed transaction, the first trading card portfolio.

### CROSS-REFERENCE TO RELATED APPLICATION

This application claims the benefit of U.S. Provisional Application Ser. No. 63/431,148 titled Systems and Methods for Computer Implemented Trading Card Marketplace filed Dec. 8, 2022, which is hereby incorporated herein by reference in its entirety.

### FIELD OF INVENTION

The present disclosure relates generally to a system, method, and computer program product that can assist trading card collectors to perform exchanges of trading cards.

### BACKGROUND

Although the current trading card market includes several buyer and seller marketplaces that offer a variety of services, none allow users to view the portfolios of other users and allow users to propose trades between one another. Current solutions within the trading card market segment also lack a “middleman” to assist with the verification of cards and facilitation of trades between collectors. Furthermore, today's existing trading card market does not provide an objective measure, such as a fairness value, to evaluate trades between users, which can encourage mutual satisfaction in proposed and executed trades. These gaps in the market offerings can expose trading card collectors to risks, such as procuring non-authentic trading cards, lack of transparency in condition appraisal of trading cards, a party's failure to provide a trading card as agreed to, and overall poor customer experiences when attempting to enter into trading card transactions.

Thus, there is a need for systems, methods, and computer programs that can assist trading card collectors in performing exchanges of trading cards amongst themselves.

### SUMMARY

In some embodiments, a computer implemented method in a data processing system can include a processor and a memory that can comprise instructions, which can be executed by the processor that can cause the processor to implement the method of facilitating exchanges of trading cards between one or more users. In some embodiments, the method can include receiving, from a first user a plurality of trading card records; generating, by the processor, a first trading card portfolio; assigning, by the processor, the first plurality of trading card records to the first trading card portfolio; executing, by the processor, a transaction; and updating, by the processor, based on the executed transaction, the first trading card portfolio.

In some embodiments, the method can further include generating, by the processor, a second trading card portfolio of a second user, wherein executing the transaction can comprise a virtual sale of the one of the first plurality of trading card records.

In some embodiments, the method can further include assigning a currency to the first trading card portfolio; un-assigning the one of the first plurality of trading card records from the first trading card portfolio; and assigning the one of the trading records to the second trading card portfolio. In any of the embodiments disclosed herein, the currency can be virtual currency.

In some embodiments, the method can further include verifying, by the processor, that the one of the first plurality of trading card records can comprise a first graded score, wherein the first graded score can indicate a first condition of the one of the first plurality of trading card records.

In some embodiments, the method can further include receiving from a middleman, a first graded score indicating a first condition of the one of the first plurality of trading card records; assigning, by the system, the second plurality of trading card records to the second trading card portfolio; wherein executing the transaction can comprise a virtual trade of the one of the first plurality of trading card records with one of the second plurality of trading card records.

In some embodiments, the method can further include un-assigning the one of the first plurality of trading card records from the first trading card portfolio; assigning the one of the first plurality of trading card records to the second trading card portfolio; un-assigning the one of the second plurality of trading card records from the second trading card portfolio; and assigning the one of the second plurality of trading card records to the first trading card portfolio. In any of the embodiments disclosed herein, the first trading card portfolio can be assigned virtual currency.

In some embodiments, the method can further include a virtual trade of the one of the first plurality of trading card records and at least some of the virtual currency with one of the second plurality of trading card records.

In some embodiments, the method can further include un-assigning the at least some of the virtual currency from the first trading card portfolio; assigning the at least some of the virtual currency to the second trading card portfolio; un-assigning the one of the first plurality of trading card records from the first trading card portfolio; assigning the one of the first plurality of trading card records to the second trading card portfolio; un-assigning the one of the second plurality of trading card records from the second trading card portfolio; and assigning the one of the second plurality of trading card records to the first trading card portfolio.

In some embodiments, the method can further include verifying, by the processor, that the one of the first plurality of trading card records can comprise a first graded score and that the one of the second plurality of trading card records can comprise a second graded score. The first graded score can indicate a first condition of the one of the first plurality of trading card records and the second graded score can indicate a second condition of the one of the second plurality of trading card records.

In some embodiments, the method can further include receiving, from a middleman, a first graded score indicating a first condition of the one of the first plurality of trading card records and a first date the middleman provided the first graded score; and receiving, from a middleman, a second graded score indicating a second condition of the one of the first plurality of trading card records and a second date the middleman provided the second graded score.

In some embodiments, the method can further include calculating, by the processor, a first card value of the one of the first plurality of trading cards; calculating, by the processor, a second card value of the one of the second plurality of trading cards; comparing, by the processor, the first card value and the second card value; determining, based on the comparison, a fairness of a trade of the first plurality of trading cards with the one of the second plurality of trading cards; and displaying, to the first user, a visual representation of the fairness.

In any of the embodiments disclosed herein, the first plurality of trading card records can comprise information about the one of the first plurality of trading cards wherein the information can comprise one or more of a photograph, certification number, year, set, condition, sport, genre, and game of one or more of the trading cards of the first plurality of trading cards. In any of the embodiments disclosed herein, the condition can be one of damaged, heavily played, moderately played, lightly played, near mint, and mint.

In some embodiments, the method can further include calculating the first card value based on the information; receiving from the first user, a desired trading card record, wherein the desired trading card record can comprise information about a trading card the first user wants; calculating the second card value which can comprise calculating the second card value based on the desired trading card record.

In some embodiments, the method can further include receiving, from a second user, a second plurality of trading cards records; receiving, from a third user, a third plurality of trading card records; and identifying, by the processor, a subset of the second plurality of trading cards records and the third plurality of trading cards records having one or more similar attributes, wherein an attribute can comprise one or more of a photograph, certification number, year set, condition, sport, game, and genre, wherein executing the transaction can comprise a virtual sale of the subset to the first user.

In some embodiments, the method can further include suggesting, by the processor, the transaction. In some embodiments, suggesting the transaction can include calculating, by the processor, a first card value of the one of the first plurality of trading cards; calculating, by the processor, a second card value of the one of the second plurality of trading cards; comparing, by the processor, the first card value and the second card value; determining, based on the comparison, a fairness of a trade of the one of the first plurality of trading cards with the one of the second plurality of trading cards; and determining, by the processor, that the fairness of a trade exceeds a threshold.

Another embodiment of the present disclosure generally relates to a computer program product for facilitating exchanges of trading cards between one or more users, the computer program product can comprise a computer readable storage medium having program instructions embodied therewith, the program instructions executable by a processor that can cause the processor to: receive, from a user, a first plurality of trading card records; generate, by the processor, a first trading card portfolio; assign, by the processor, the first plurality of trading card records to the first trading card portfolio; calculate, by the processor, a first card value of the one of the first plurality of trading cards; receive, from a second user, a second plurality of trading card records; create, by the processor, a second trading card portfolio of a second user; assign, by the processor, the second plurality of trading card records to the second trading card portfolio; calculate, by the processor, a second card value of the one of the second plurality of trading cards; compare, by the processor, the first card value and the second card value; determine, based on the comparison, a fairness of a trade of the one of the first plurality of trading cards with the one of the second plurality of trading cards; display, to the first user, a visual representation of fairness; execute, by the processor, a virtual trade of the one of the first plurality of trading card records with one of the second plurality of trading card records; and update, by the processor, based on the virtual trade, the first trading card portfolio.

Another embodiment of the present disclosure generally relates to a system for facilitating exchanges of trading cards between one or more users, the system can comprise a portfolio module, a trade builder module. The portfolio module can be configured to: receive, from a first user, a first plurality of trading records, generate a first trading card portfolio; assign the first plurality of trading card records to the first trading card portfolio; receive, from a second user, a second plurality of trading card records; creating a second trading card portfolio of a second user; assign, by the system, the second plurality of trading card records to the second trading card portfolio; and update, based on a virtual trade, the first trading card portfolio. The trade builder module can be configured to: calculate a first card value of the one of the first plurality of trading cards; calculate a second card value of the one of the second plurality of trading cards; compare the first card value and the second card value; determine a fairness of a trade of the one of the first plurality of trading cards with the one of the second plurality of trading cards; display, to the first user, a visual representation of the fairness; and execute a virtual trade of the one of the first plurality of trading card records with one of the second plurality of trading card records.

This summary is provided to introduce a selection of concepts in a simplified form that are further described below in the detailed description. This summary is not intended to identify key features or essential features of the claimed subject matter, nor is it intended to be used to limit the scope of the claimed subject matter. Additional features and advantages of the disclosed technology will be made apparent from the following detailed description of illustrative embodiments that proceeds with reference to the accompanying drawings.

### BRIEF DESCRIPTION OF THE DRAWINGS

The foregoing and other aspects of the present disclosure are best understood from the following detailed description when read in connection with the accompanying drawings. For the purpose of illustrating the disclosed technology, there are shown in the drawings embodiments that are presently preferred, it being understood, however, that the disclosed technology is not limited to the specific instrumentalities disclosed. Included in the drawings are the following Figures:

FIG. 1A is a first partial view of a feature map of an exemplary computer implemented method for exchanging trading cards between one or more users, in accordance with an embodiment of the present invention;

FIG. 1B is a second partial view of a feature map of an exemplary computer implemented method, shown in FIG. 1A, for exchanging trading cards between one or more users, in accordance with an embodiment of the present invention;

FIG. 2A is a flow chart of an exemplary embodiment of obtaining value of a trading card, in accordance with an embodiment of the present invention;

FIG. 2B is a flow chart of an exemplary embodiment of a method for executing exchanges of trading cards, in accordance with an embodiment of the present invention;

FIG. 3 is an example illustration of a trade builder module, in accordance with an embodiment of the present invention;

FIG. 4A. is a flow chart of an exemplary embodiment of a method for purchasing a mystery pack, in accordance with an embodiment of the present invention;

FIG. 4B is a flow chart of an exemplary embodiment of a method for converting trading cards to virtual currency, in accordance with an embodiment of the present invention;

FIG. 5A is a flow chart of an exemplary embodiment of a method for receiving reward points from executing exchanges of trading cards, in accordance with an embodiment of the present invention;

FIG. 5B is a flow chart of an exemplary embodiment of a method for searching for types of collections of trading cards, in accordance with an embodiment of the present invention; and

FIG. 6. illustrates an exemplary computing environment, in accordance with an embodiment of the present invention.

### DETAILED DESCRIPTION

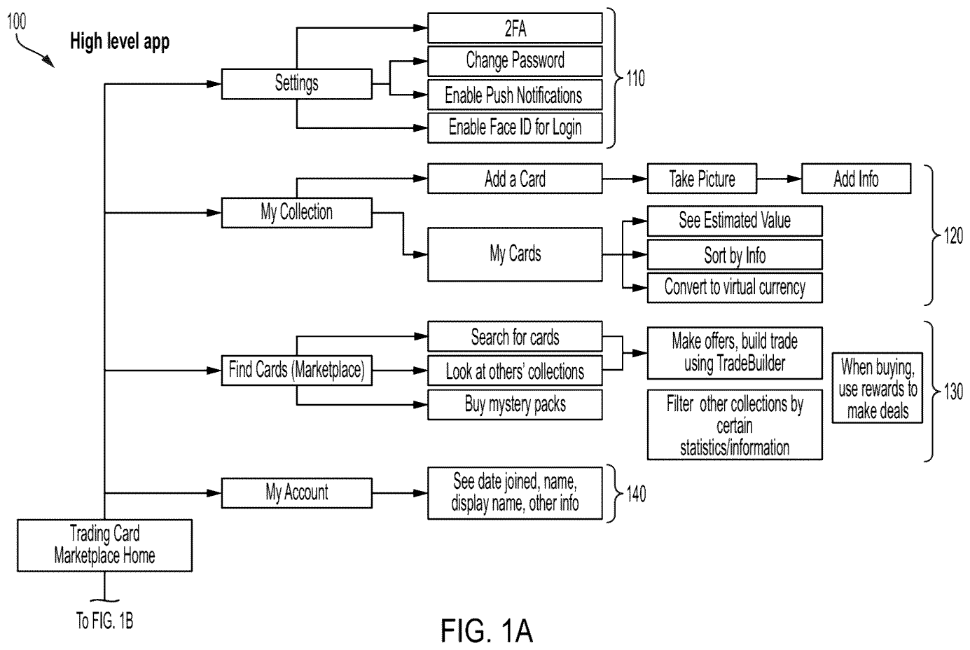

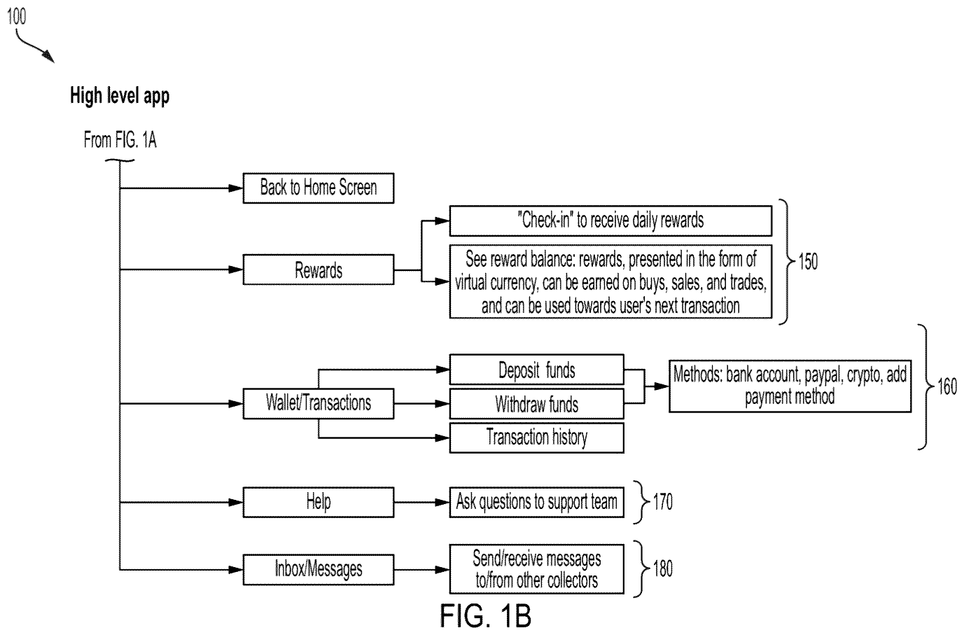

The technical problem addressed by the present disclosure is that trading card collectors lack a method or system to facilitate objectively fair exchanges of authentic trading cards without the risk of scams and fraudulent transactions. The technical solution to this technical problem is to provide computer implemented systems and methods for determining objectively fair exchanges of authentic trading cards and for facilitating safe, secure exchanges of authentic trading cards between trading card collectors. The technology within this disclosure generally relates to a computer implemented method that can be used in a data processing system to facilitate exchanges of trading cards between one or more users. FIGS. 1A-1B are partial views of a feature map of an exemplary computer implemented method 100 for exchanging trading cards. Example embodiments of the exemplary computer implemented method 100 shown in FIG. 1 can include, but not be limited to, a mobile application, desktop application, internet application, and the like.

As shown in FIG. 1A, the exemplary computer program product 100 can have one or more features accessible by a user. In some embodiments, the user can access a “Settings” 110 pane within the exemplary computer program product 100, which can allow the user to update security credentials, declare authentication preferences such as dual factor authentication (2 FA), and receive push notifications regarding the user's account. The user can also access a “My Collection” pane within the exemplary computer program product 100, which can allow the user to view a portfolio containing their trading cards, add new trading cards to the portfolio, and convert a value of the portfolio into a form of virtual currency. The user can also access a “Find Cards” pane within the exemplary computer program product 100, which can allow the user to utilize the exemplary computer program product 100 to search for trading cards that the user wants, purchase mystery packs containing training cards, and view the portfolios of other users. The user can also access a “My Account” pane within the exemplary computer program product 100, which can allow the user to view account status information as shown in FIG. 1A.

As shown in FIG. 1B, the user can access a “Rewards” 150 pane via the computer program product 100, which can allow the user to view and access a Rewards balance for use within the exemplary computer program product 100 as a type of virtual currency. In some embodiments, the user can access the “Rewards” 150 pane to complete activities, such as a “Check-In”, to increase the Reward balance within the user's account. The user can also access a “Wallet/Transactions” 160 pane via the computer program product 100, which can allow the user to deposit or withdraw a form of currency into or from the user's account. In some embodiments, the user can deposit or withdraw the form of currency into a bank account, a financial technology application, a cryptocurrency, and the like. The user, within the “Wallet/Transactions” 160 pane and via the exemplary computer program product 100, can view their respective transaction history with other users. The user can also access a “Help” 170 pane via the exemplary computer program product 100, which can allow the user to submit a help ticket for problems with the user's account. The user can also access a “Inbox/Messages” 180 pane via the exemplary computer program product 100, which can allow the user to communicate with other users.

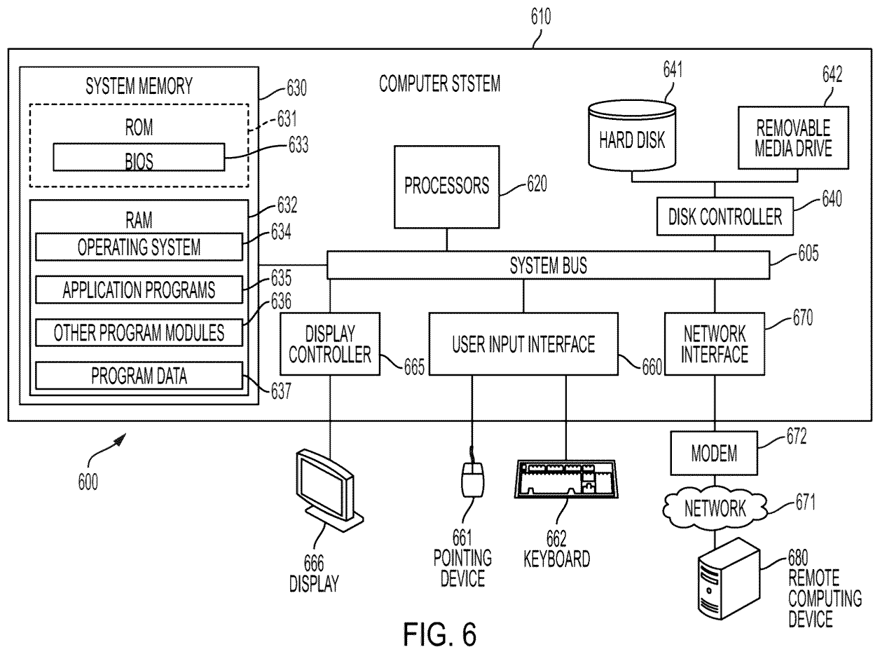

The exemplary computer program product 100 can perform the capabilities shown in FIGS. 1A-1B via a data processing system. In some embodiments, the data processing system can be a computer environment as shown in FIG. 6. The features of the exemplary computer program product can include, but not be limited to, allowing users to share their trading card portfolios 130, uploading images of their individual cards to create their portfolio, viewing other participants' portfolios while filtering what types of collections they would like to evaluate for potential trades, and offering or executing trades using a trade builder module 300. Additionally, users can mark their own trading cards as available for trade, for sale, and can list trading cards they are looking to obtain in order to engage with other users.

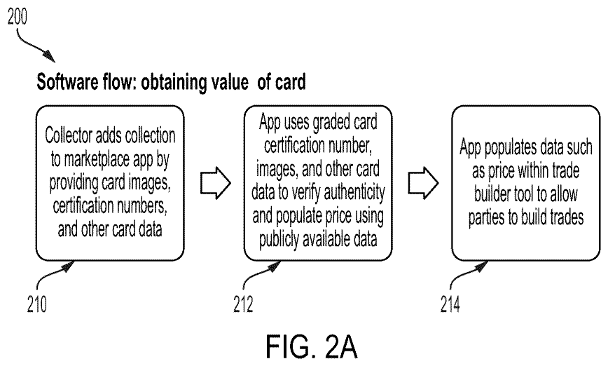

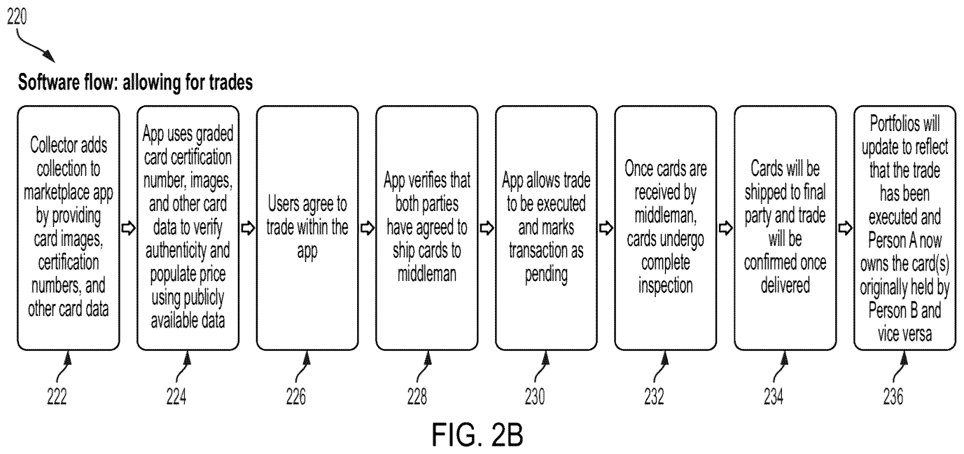

FIG. 2A is a flow chart 200 of an exemplary embodiment of obtaining value of a trading card. As shown in FIG. 2A, the user can obtain the value of a trading card by performing a step 210, which can include providing card images, certification numbers and other card data. The user's portfolio can record information about each of the individual trading cards stored within the portfolio. Examples of recorded information 340 within a user's portfolio can include, but not be limited to, year, subject, sport/genre/game, owner, certification, grade, and other similar information about the trading card. In some embodiments, the individual trading cards uploaded into the portfolio can be graded or ungraded. As known in the art, there can be two types of trading cards within the trading card market segment: graded trading cards and ungraded trading cards. Graded trading cards are trading cards that have been evaluated by an authenticator and given a condition score and/or a certification number. Examples of authentication services that can provide grades to trading cards are CGC and PSA. Conversely, ungraded trading cards have not had their condition and authenticity appraised by an authentication service. In some embodiments, in the case of ungraded trading cards, the exemplary computer program product 100, can require users to ship ungraded trading cards to a middleman to verify recorded information for the ungraded trading card, which can be a requirement before the trading cards can become eligible for trades with other users.

Once the user has completed step 210, in the case of graded trading cards, the user can then perform a step 212 of using the graded trading card certification number, uploaded images of the trading card, and other recorded information 340 to determine price information for the graded trading card. The exemplary computer implemented method 100 can populate and display the price information in a trade builder module 300 that both users can view in order to build a proposed trade.

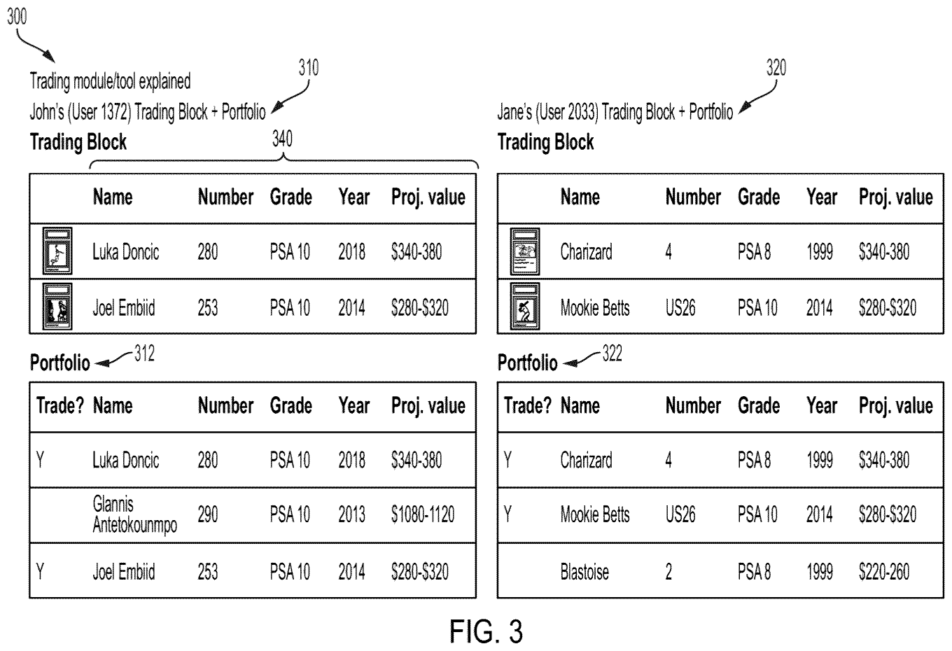

As mentioned previously, once a user has uploaded a trading card to their trading card portfolio, which can include both graded and ungraded cards, the user can build a trade with another user using the trade builder module 300, shown in FIG. 3. In some embodiments, the trade builder module can be used to propose and execute trades of trading cards between users. The trade builder module can provide recorded information 340 about individual trading cards that users own within their respective portfolios. This recorded information 340 can include, but not be limited to, trading card value, condition, grade, year, type, images of the trading card, and the like. Users can also indicate trading cards that they desire for their respective portfolios, which can be displayed to both users within the trade builder module 300. For example, User A 310 can offer one or more trading cards from their portfolio 312 in exchange for one or more trading cards from User B's 320 portfolio 322. Alternatively, in some embodiments, the computer implemented method 100 itself can suggest trades based on User A's 310 preferences and User B's 320 preferences.

Within the trade builder module 300, illustrated in FIG. 3, the recorded information 340 for the one or more trading cards can be shown to both User A 310 and User B 320 to construct a proposed trade. In some embodiments, once both User A 310 and User B 320 agree to the proposed trade in the trade builder module 300, both User A 310 and User B 320 can ship their respective trading cards to the middleman who then ships the trading cards to the users.

However, as one of ordinary skill in the art will appreciate, the subject matter disclosed herein is not so limited. Instead, the users could ship the trading cards directly to each other. In some embodiments, before the users ship directly to each other without a middleman, they may be required to demonstrate patterns of consistent positive activity to orchestrate their own trades, which could include but not be limited to multiple successful transactions, absence of negative reviews from other users, absence of attempted scamming and the like.

In some embodiments, the computer implemented method 100 can require that all proposed trades be executed through the middleman. The middleman can receive and inspect the conditions of the trading cards sent by both users. Upon satisfactory inspection of both users' trading cards by the middleman, the computer implemented method can notify the users that the trade is authorized. The computer implemented method 100 can then update the portfolios of both users to reflect the exchange of trading cards between the users. If the middleman is unable to verify either of the users' trading cards, the computer implemented method 100 can notify both users that the trade was not executed. In turn, the users' trading cards that were unable to be verified by the middleman are returned and can no longer be used in future trading card exchanges.

In addition to this recorded information 340, the computer implemented method 100 can determine a fairness of a trade, which can be based on the trading cards proposed between the users and the trading cards desired by both users. For example, based on recorded information 340 for User A's 310 trading cards and User B's 320 trading cards such as those shown in FIG. 3, the trade builder module 300 can calculate a fairness of trade value, which can be a weighted value calculation derived from comparing recorded information 340 obtained from the users' trading cards and considering the trading cards indicated as desired by both users. For example, in some embodiments, the fairness of a trade value can be based on recorded information like historical price and user interest in the offered card. For example, in some embodiments, the historical price can account for 85%-95% of the fairness value and user interest in the offered trading cards can account between 5%-15% of the fairness value. However, as one of ordinary skill in the art will appreciate, the fairness value can be based on different percentages of historical price and user interest or recorded information other than historical price and user interest.

Once calculated, the computer implemented method 100 can display a visual representation of the fairness of the trade between User A 310 and User B 320. The visual representation of fairness can be advantageous between users as it can allow them to objectively evaluate if a proposed exchange of trading cards is a worthwhile trade. In some embodiments the fairness value can be associated with a label displayed to a user. For example, depending on the fairness value, a trade can be “not fair,” “pretty fair,” “fair,” and the like. Alternatively or additionally, the fairness value can be represented visually, for example, with a meter having colors that can correspond with the fairness of the proposed trades. For example, for a “fair” trade, the meter may be green; for a “pretty fair” trade, the meter may be yellow; and for a “not fair” trade, the meter may be red. In some embodiments, calculated trade fairness values for each user that are within 10% of each other can be deemed as a “fair” trade. As one skilled in the art can appreciate, these calculations can provide an objective evaluation of proposed trades, which may suggest whether a trade is fair for both users.

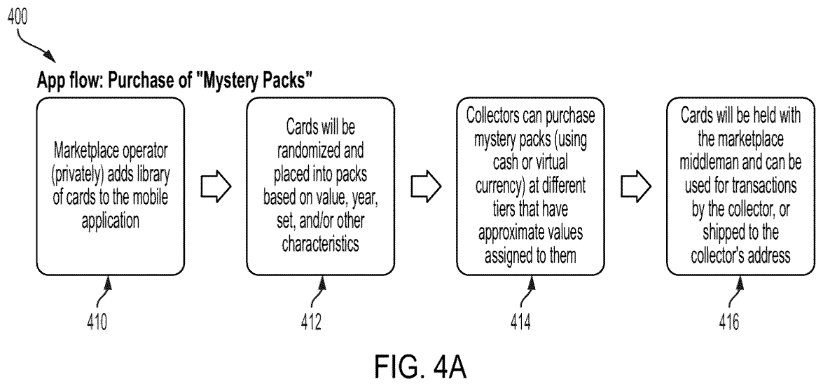

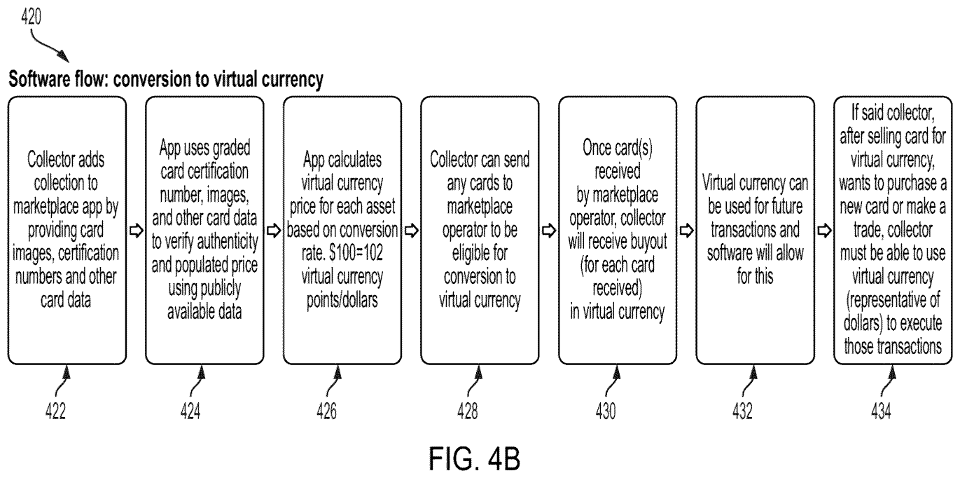

FIG. 4A is a flow chart of an exemplary embodiment of a method 400 for purchasing a mystery pack using the computer implemented method 100 described herein. Within the computer implemented method 100, a method step 410 of the method 400 for purchasing the mystery pack can include an admin user or marketplace operator maintaining a private portfolio of trading cards. The next method step 412, as shown in FIG. 4A, of the method 400 for purchasing the mystery pack can include randomizing the trading cards within the private portfolio of the admin user prior to placing them into mystery packs. As one who is skilled in the art can appreciate, mystery packs for trading cards can include trading cards of varying degrees of rarity, value, and type. In the present exemplary embodiment of the method 400, as shown in FIG. 4A, the trading cards can be organized within the mystery packs based on recorded information previously described, such as value, year, type, and the like. The mystery packs, within the computer implemented method, are tiered for purchase, which can be based on the approximate value of the trading cards contained within the mystery packs. The next method step 414, as shown in FIG. 4A, of the method 400 for purchasing the mystery pack can include users, within the computer implemented method 100, using currency to purchase mystery packs. The next method step 416, as shown in FIG. 4A, of the method for purchasing the mystery pack can include having the trading cards shipped to the user, at the user's request, or having the trading cards held by the middleman for use in future trading card exchanges with other users.

FIG. 4B is a flow chart of an exemplary embodiment of a method 420 for converting trading cards to virtual currency. In addition to exchanges of trading cards, a user can execute a virtual sale of a trading card with an admin user in accordance with the exemplary method 420 shown in FIG. 4B. A method step 422 of the method 420 for converting trading cards to virtual currency can include a user adding one or more trading cards to their respective portfolio with the corresponding recorded information 340. For example, User A 310 can have multiple trading cards in their portfolio 312, which the user can indicate as being for sale via the computer implemented method 100 described herein. The method 420 can include a method step 424 that can include the computer implemented method 100 using the recorded information 340 of the one or more trading cards to verify authenticity and populate price corresponding to the one or more trading cards. The method 420 can include a method step 426 that can include the computer implemented method calculating a virtual currency price for each of the one or more trading cards. The method 420 can include the method step 428 of the user sending the trading cards to an admin user of the computer implemented method 100 to validate and execute the conversion to virtual currency. In other words, User A 310 can then exchange the trading cards that they wish to sell, via the computer implemented method 100, for currency from the admin user. In some embodiments, the currency can be a virtual currency. The admin user can request the trading cards from User A 310 to inspect the condition and verify authenticity of the trading cards offered for sale. The method 420 can include the method step 430 which can include the user receiving a buyout in virtual currency for each card received by the admin user. Once received and inspected, the admin user can authorize the computer implemented method 100 to disperse virtual currency to User A's 310 portfolio 312. The method 420 can also include the method step 432 which can include the user leveraging the virtual currency for future transactions within the computer implemented method 100 described herein. As should be appreciated, virtual currency, with respect to the present disclosure, can be considered digital currency, issued by the admin user, that may be used as a medium of exchange. Virtual currency may or may not be convertible to a desired native currency of the user. Native currency can include but not be limited to the U.S. Dollar (USD), euros (EUR), and the like.

In some embodiments, users can offer a combination of virtual or real currency and trading cards when proposing exchanges of trading cards within the trade builder module. For example, if User A 310 desires a trading card within the portfolio 322 of User B 320, User A 310, within the trade builder module 300, can offer one or more trading cards and an amount of virtual or real currency from User A 310's portfolio 312 in exchange for the trading card within User B's 320 portfolio 322. The advantage for User A 310 offering virtual currency and one or more trading cards is that it can increase the likelihood of an accepted trade for the desired trading card in User B's 320 portfolio 322. For strategic purposes, User A 310 or User B 320 can examine the projected value of a desired trading card, using the trade builder module 300, and can determine an offered amount of virtual currency. The fairness value, which as discussed previously can be a weighted value calculation derived from comparing recorded information obtained from the users' trading cards, can also consider the amount of virtual currency offered by either user in calculating the fairness of a trading card exchange between users. Once the trade is accepted by both User A 310 and User B 320, the trading cards can be sent to the middleman for inspection. Upon satisfactory inspection of the trading cards by the middleman, the trading cards are released to User A 310 and User B 320. However, as one of ordinary skill in the art will appreciate, the subject matter disclosed herein is not so limited. Instead, once the trade is accepted by both User A 310 and User B 320, they can send the traded trading cards to each other. Additionally, the amount of virtual currency added or subtracted from either user's portfolios can be adjusted to correspond to the terms of the exchange of trading cards accepted by both users.

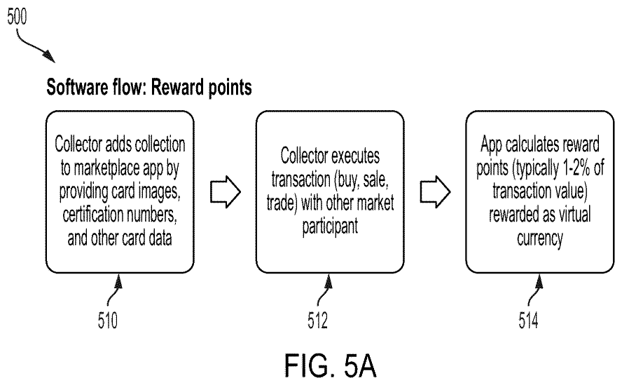

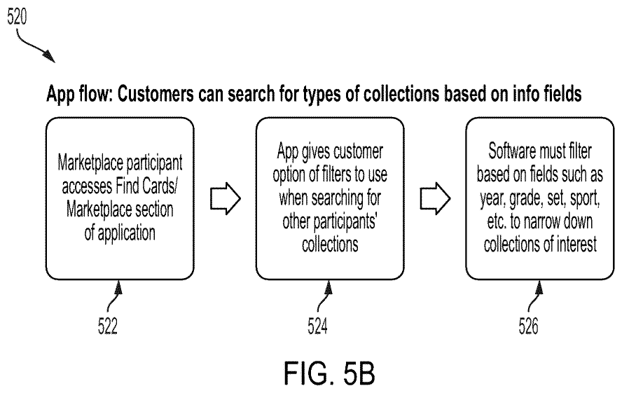

FIG. 5A is a flow chart of an exemplary embodiment of a method 500 for receiving reward points from executing exchanges of trading cards. As one who is skilled in the art can appreciate, incentivized systems like reward points can encourage compliance and can foster community amongst users within virtual marketplaces. As shown in FIG. 5A, the method 500 can include a method step 510 which can include users uploading one or more trading cards to their respective portfolios with corresponding recorded information 340. The method 500 can include a method step 512 which can include users executing successful transactions with other users via the computer implemented method 100 disclosed herein for exemplary purposes. The transactions can include, but are not limited to, purchases of trading cards, sales of trading cards, trades of trading cards, and the like. The method 500 can include a method step 514 which can include the computer implemented method 100 calculating a reward point allocation per transaction to users administered as virtual currency. The computer implemented method 100 described herein can calculate and can award reward points for successful transactions between users. For example, User A 310 and User B 320 can accept and execute a trade for trading cards from their respective portfolios. The trade can be confirmed as a successful transaction after the trading cards from both users receive a satisfactory inspection from the middleman. Once the transaction is confirmed, the computer can award reward points to both users. In some embodiments, the reward points can be awarded as virtual currency that can be added to the portfolios of both users for use in future transactions.

FIG. 5B is a flow chart of an exemplary embodiment of a method 520 for searching for types of collections of trading cards. As shown in FIG. 5B, the method 520 can include a method step 512 which can include users accessing the “Find Cards/Marketplace” section of the computer implemented method as shown in FIG. 1A. The method 520 can include a method step 524 which can include the computer implemented method providing one or more search filters for users to elect when searching other users' portfolios. Users can use the computer implemented method 100 described herein to find desired trading cards for their respective portfolios. As discussed previously, a user's portfolios can contain recorded trading card information, which can correspond to the individual trading cards uploaded by the user. Therefore, a user can search other user's portfolios using recorded trading card information 340 to find a desired trading card. Recorded trading card information 340, as shown in FIG. 5B, can include, but not be limited to, year, subject, sport, genre, game, owner, certification, grade, and the like. For instance, User A 310 can query the computer implemented method to find portfolios that can contain trading cards that User A 310 may desire for their portfolio. The method 520 may also include a method step 526 which can include the computer implemented method 100 returning portfolios of interest to users based on the one or more search filters. In other words, once the query is executed, the computer implemented method 100 can display portfolios of other users, which can contain User A's 310 desired trading card and correspond to User A's 310 query.

FIG. 6 illustrates an exemplary computing environment 600 within which embodiments of the invention may be implemented. For example, this computing environment 600 may be configured to execute a method of placing an item having irregular dimensions. The computing environment 600 may include computer system 610, which is one example of a computing system upon which embodiments of the invention may be implemented. Computers and computing environments, such as computer system 610 and computing environment 600, are known to those of skill in the art and thus are described briefly here.

As shown in FIG. 6, the computer system 610 may include a communication mechanism such as a bus 605 or other communication mechanism for communicating information within the computer system 610. The computer system 610 further includes one or more processors 620 coupled with the bus 605 for processing the information. The processors 620 may include one or more central processing units (CPUs), graphical processing units (GPUs), or any other processor known in the art.

The computer system 610 also includes a system memory 630 coupled to the bus 605 for storing information and instructions to be executed by processors 620. The system memory 630 may include computer readable storage media in the form of volatile and/or nonvolatile memory, such as read only memory (ROM) 631 and/or random access memory (RAM) 632. The system memory RAM 632 may include other dynamic storage device(s) (e.g., dynamic RAM, static RAM, and synchronous DRAM). The system memory ROM 631 may include other static storage device(s) (e.g., programmable ROM, erasable PROM, and electrically erasable PROM). In addition, the system memory 630 may be used for storing temporary variables or other intermediate information during the execution of instructions by the processors 620. A basic input/output system (BIOS) 633 containing the basic routines that help to transfer information between elements within computer system 610, such as during start-up, may be stored in ROM 631. RAM 632 may contain data and/or program modules that are immediately accessible to and/or presently being operated on by the processors 620. System memory 630 may additionally include, for example, operating system 634, application programs 635, other program modules 636 and program data 637.

The computer system 610 also includes a disk controller 640 coupled to the bus 605 to control one or more storage devices for storing information and instructions, such as a hard disk 641 and a removable media drive 642 (e.g., floppy disk drive, compact disc drive, tape drive, and/or solid state drive). The storage devices may be added to the computer system 610 using an appropriate device interface (e.g., a small computer system interface (SCSI), integrated device electronics (IDE), Universal Serial Bus (USB), or FireWire).

The computer system 610 may also include a display controller 665 coupled to the bus 605 to control a display 666, such as a cathode ray tube (CRT) or liquid crystal display (LCD), for displaying information to a computer user. The computer system 610 includes an input interface 660 and one or more input devices, such as a keyboard 662 and a pointing device 661, for interacting with a computer user and providing information to the processor 620. The pointing device 661, for example, may be a mouse, a trackball, or a pointing stick for communicating direction information and command selections to the processor 620 and for controlling cursor movement on the display 666. The display 666 may provide a touch screen interface which allows input to supplement or replace the communication of direction information and command selections by the pointing device 661.

The computer system 610 may perform a portion or all of the processing steps of embodiments of the invention in response to the processors 620 executing one or more sequences of one or more instructions contained in a memory, such as the system memory 630. Such instructions may be read into the system memory 630 from another computer readable medium, such as a hard disk 641 or a removable media drive 642. The hard disk 641 may contain one or more datastores and data files used by embodiments of the present invention. Datastore contents and data files may be encrypted to improve security. The processors 620 may also be employed in a multi-processing arrangement to execute the one or more sequences of instructions contained in system memory 630. In alternative embodiments, hard-wired circuitry may be used in place of or in combination with software instructions. Thus, embodiments are not limited to any specific combination of hardware circuitry and software.

As stated above, the computer system 610 may include at least one computer readable medium or memory for holding instructions programmed according to embodiments of the invention and for containing data structures, tables, records, or other data described herein. The term “computer readable medium” as used herein refers to any medium that participates in providing instructions to the processor 620 for execution. A computer readable medium may take many forms including, but not limited to, non-volatile media, volatile media, and transmission media. Non-limiting examples of non-volatile media include optical disks, solid state drives, magnetic disks, and magneto-optical disks, such as hard disk 641 or removable media drive 642. Non-limiting examples of volatile media include dynamic memory, such as system memory 630. Non-limiting examples of transmission media include coaxial cables, copper wire, and fiber optics, including the wires that make up the bus 605. Transmission media may also take the form of acoustic or light waves, such as those generated during radio wave and infrared data communications.

The computing environment 600 may further include the computer system 610 operating in a networked environment using logical connections to one or more remote computers, such as remote computer 680. Remote computer 680 may be a personal computer (laptop or desktop), a mobile device, a server, a router, a network PC, a peer device, or other common network node, and typically includes many or all of the elements described above relative to computer system 610. When used in a networking environment, computer system 610 may include modem 672 for establishing communications over a network 671, such as the Internet. Modem 672 may be connected to bus 605 via user network interface 670, or via another appropriate mechanism.

Network 671 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 610 and other computers (e.g., remote computer 680). The network 671 may be wired, wireless or a combination thereof. Wired connections may be implemented using Ethernet, Universal Serial Bus (USB), RJ-11 or any other wired connection generally known in the art. Wireless connections may be implemented using Wi-Fi, WiMAX, and Bluetooth, infrared, cellular networks, satellite, or any other wireless connection methodology generally known in the art. Additionally, several networks may work alone or in communication with each other to facilitate communication in the network 671.

The embodiments of the present disclosure may be implemented with any combination of hardware and software. In addition, the embodiments of the present disclosure may be included in an article of manufacture (e.g., one or more computer program products) having, for example, computer-readable, non-transitory media. The media has embodied therein, for instance, computer readable program code for providing and facilitating the mechanisms of the embodiments of the present disclosure. The article of manufacture can be included as part of a computer system or sold separately.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

To facilitate an understanding of the principles and features of the various embodiments of the claimed subject matter, various illustrative embodiments are explained above. Although exemplary embodiments of the claimed subject matter are explained in detail, it is to be understood that other embodiments are contemplated. Accordingly, it is not intended that the claimed subject matter is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose. Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the claimed subject matter are intended to be illustrative and not restrictive. Many suitable materials that would perform the same or a similar function as the materials described herein are intended to be embraced within the scope of the claimed subject matter. Such other materials not described herein can include, but are not limited to, for example, materials that are developed after the time of the development of the claimed subject matter.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose. Similarly, as used herein, “substantially free” of something, or “substantially pure”, and like characterizations, can include both being “at least substantially free” of something, or “at least substantially pure”, and being “completely free” of something, or “completely pure”.

Numerous characteristics and advantages have been set forth in the above description, together with details of structure and function. While the claimed subject matter has been disclosed in several forms, it will be apparent to those skilled in the art that many modifications, additions, and deletions, especially in matters of shape, size, and arrangement of parts, can be made therein without departing from the spirit and scope of the claimed subject matter and its equivalents as set forth in the following claims. Therefore, other modifications or embodiments as may be suggested by the teachings herein are particularly reserved as they fall within the breadth and scope of the claims here appended.

I claim:

1. A computer implemented method in a data processing system comprising a processor and a memory comprising instructions, which are executed by the processor to cause the processor to implement the method of facilitating exchanges of trading cards between one or more users, the method comprising:
receiving, from a first user, a first plurality of trading card records;
generating, by the processor, a first trading card portfolio;
assigning, by the processor, the first plurality of trading card records to the first trading card portfolio;
executing, by the processor, a transaction; and
updating, by the processor, based on the executed transaction, the first trading card portfolio.

2. The computer implemented method of claim 1, the method further comprising:
generating, by the system, a second trading card portfolio of a second user,
wherein executing the transaction comprises a virtual sale of the one of the first plurality of trading card records.

3. The computer implemented method of claim 2, wherein updating the first trading card portfolio comprises:
assigning a currency to the first trading card portfolio;
un-assigning the one of the first plurality of trading card records from the first trading card portfolio; and
assigning the one of the first plurality of trading card records to the second trading card portfolio.

4. The computer implemented method of claim 2, wherein the currency is virtual currency.

5. The computer implemented method of claim 2, the method further comprising:
verifying, by the processor, that the one of the first plurality of trading card records comprises a first graded score, wherein the first graded score indicates a first condition of the one of the first plurality of trading card records.

6. The computer implemented method of claim 2, the method further comprising:
receiving, from a middleman, a first graded score indicating a first condition of the one of the first plurality of trading card records.

7. The computer implemented method of claim 1, the method further comprising:
receiving, from a second user, a second plurality of trading card records;
creating, by the system, a second trading card portfolio of a second user; and
assigning, by the system, the second plurality of trading card records to the second trading card portfolio,
wherein executing the transaction comprises a virtual trade of the one of the first plurality of trading card records with one of the second plurality of trading card records.

8. The computer implemented method of claim 7, wherein updating the first trading card portfolio comprises:
un-assigning the one of the first plurality of trading card records from the first trading card portfolio;
assigning the one of the first plurality of trading card records to the second trading card portfolio;
un-assigning the one of the second plurality of trading card records from the second trading card portfolio; and
assigning the one of the second plurality of trading card records to the first trading card portfolio.

9. The computer implemented method of claim 7,
wherein the first trading card portfolio is assigned virtual currency, and
wherein executing the transaction comprises a virtual trade of the one of the first plurality of trading card records and at least some of the virtual currency with one of the second plurality of trading card records.

10. The computer implemented method of claim 9, wherein updating the first trading card portfolio comprises:
un-assigning the at least some of the virtual currency from the first trading card portfolio;
assigning the at least some of the virtual currency to the second trading card portfolio;
un-assigning the one of the first plurality of trading card records from the first trading card portfolio;
assigning the one of the first plurality of trading card records to the second trading card portfolio;
un-assigning the one of the second plurality of trading card records from the second trading card portfolio; and
assigning the one of the second plurality of trading card records to the first trading card portfolio.

11. The computer implemented method of claim 7, the method further comprising:
verifying, by the processor, that the one of the first plurality of trading card records comprises a first graded score and that the one of the second plurality of trading card records comprises a second graded score,
wherein the first graded score indicates a first condition of the one of the first plurality of trading card records,
wherein the second graded score indicates a second condition of the one of the second plurality of trading card records.

12. The computer implemented method of claim 7, the method further comprising:
receiving, from a middleman, a first graded score indicating a first condition of the one of the first plurality of trading card records and a first date the middleman provided the first graded score; and
receiving, from a middleman, a second graded score indicating a second condition of the one of the first plurality of trading card records and a second date the middleman provided the second graded score.

13. The computer implemented method of claim 7, the method further comprising:
calculating, by the processor, a first card value of the one of the first plurality of trading cards;
calculating, by the processor, a second card value of the one of the second plurality of trading cards;
comparing, by the processor, the first card value and the second card value;
determining, based on the comparison, a fairness of a trade of the one of the first plurality of trading cards with the one of the second plurality of trading cards; and
displaying, to the first user, a visual representation of the fairness.

14. The computer implemented method of claim 13, wherein the first plurality of trading card records comprises information about the one of the first plurality of trading cards, wherein the information comprises one or more of a photograph, certification number, year, set, condition, sport, genre, and game of one or more of the trading cards of the first plurality of trading cards.

15. The computer implemented method of claim 14, wherein the condition is one of damaged, heavily played, moderately played, lightly played, near mint, and mint.

16. The computer implemented method of claim 15, wherein calculating the first card value comprising calculating the first card value based on the information.

17. The computer implemented method of claim 13, further comprising:
receiving, from the first user, a desired trading card record, wherein the desired trading card record comprises information about a trading card the first user wants,
wherein calculating the second card value comprising calculating the second card value based on the desired trading card record.

18. The computer implemented method of claim 1, further comprising:
receiving, from a second user, a second plurality of trading cards records;
receiving, from a third user, a third plurality of trading card records; and
identifying, by the processor, a subset of the second plurality of trading cards records and the third plurality of trading cards records having one or more similar attributes, wherein an attribute comprises one or more of a photograph, certification number, year, set, condition, sport, genre, and game,
wherein executing the transaction comprises a virtual sale of the subset to the first user.

19. The computer implemented method of claim 1, the method further comprising:
suggesting, by the processor, the transaction, wherein suggesting the transaction comprises:
calculating, by the processor, a first card value of the one of the first plurality of trading cards,
calculating, by the processor, a second card value of the one of the second plurality of trading cards,
comparing, by the processor, the first card value and the second card value,
determining, based on the comparison, a fairness of a trade of the one of the first plurality of trading cards with the one of the second plurality of trading cards, and
determining, by the processor, that the fairness of a trade exceeds a threshold.

20. A computer program product for facilitating exchanges of trading cards between one or more users, the computer program product comprising a computer readable storage medium having program instructions embodied therewith, the program instructions executable by a processor to cause the processor to:
receive, from a first user, a first plurality of trading card records;
generate, by the processor, a first trading card portfolio;
assign, by the processor, the first plurality of trading card records to the first trading card portfolio;
calculate, by the processor, a first card value of the one of the first plurality of trading cards;
receive, from a second user, a second plurality of trading card records;
create, by the processor, a second trading card portfolio of a second user; and
assign, by the processor, the second plurality of trading card records to the second trading card portfolio;
calculate, by the processor, a second card value of the one of the second plurality of trading cards;
compare, by the processor, the first card value and the second card value;
determine, based on the comparison, a fairness of a trade of the one of the first plurality of trading cards with the one of the second plurality of trading cards;
display, to the first user, a visual representation of the fairness;
execute, by the processor, a virtual trade of the one of the first plurality of trading card records with one of the second plurality of trading card records; and
update, by the processor, based on the virtual trade, the first trading card portfolio.

21. A system for facilitating exchanges of trading cards between one or more users, the system comprising:
a portfolio module configured to:
receive, from a first user, a first plurality of trading card records,
generate a first trading card portfolio,
assign the first plurality of trading card records to the first trading card portfolio,
receive, from a second user, a second plurality of trading card records,
creating a second trading card portfolio of a second user,
assign, by the system, the second plurality of trading card records to the second trading card portfolio, and
update, based on a virtual trade, the first trading card portfolio; and
a trade builder module configured to:
calculate a first card value of the one of the first plurality of trading cards,
calculate a second card value of the one of the second plurality of trading cards,
compare the first card value and the second card value,
determine a fairness of a trade of the one of the first plurality of trading cards with the one of the second plurality of trading cards,
display, to the first user, a visual representation of the fairness, and
execute a virtual trade of the one of the first plurality of trading card records with one of the second plurality of trading card records.
